(19) United States
(12) Patent Application Publication
(10) Pub. No.: US 2026/0357882 A1
(43) Pub. Date: Nov. 12, 2026

(54) Progressive Limited Slip Drive

(71) Applicant: Nigel Alexander Buchanan, New Gilston (GB)

(72) Inventor: Nigel Alexander Buchanan, New Gilston (GB)

(21) Appl. No.: 19/139,810

(22) PCT Filed: Dec. 18, 2023
(86) PCT No.: PCT/GB2023/000060

§ 371 Date: Jun. 16, 2025

(30) Foreign Application Priority Data
Dec. 16, 2022 (GB) 2219053.2
Jul. 29, 2023 (GB) 2311707.0

(51) Int. Cl. F16H 48/27; F16H 48/11; F16H 48/38; H02K 7/00; H02K 7/116

(52) U.S. Cl. CPC F16H 48/27; F16H 48/11; F16H 2048/387; H02K 7/006; H02K 7/116

(57) ABSTRACT

A sealed, part filled transmission fluid 800 housing 200, wherein rotatable sun and planetary gears 500, 600 reside; the housing 200 outer casing 201 affixed between first and second plate sets 301, 302 with spacers 400 forming close fit inward and outward fluid flow passageways 402, 403 around sun and planetary gears 500, 600. The outer planetary gears 608, having no outmost gear 608 connection whatsoever. Optionally, the sun gear 500 connected to the drive input DI and the drive output DO connected via the rotationally affixed planetary gear axles 605 to the housing 200. When a difference in rotational speed between the housing 200 and the central sun gear 500 occurs, the rotated planetary gear teeth 601, acting like paddles wheels, drive the transmission fluid 800 progressively inwards towards the individual mesh points 609, 504, resulting in pumping resistance or locking action according to the transmission fluid 800 viscosity and tolerances between the mesh points 504, 609 of the respective gears 500, 606, 607 and 608 thus providing progressive slip limitation between the sun gear 500 and housing 200.

### FIELD OF INVENTION

The invention relates to limited slip drives, automatic gearboxes and torque convertors, also but not exclusively vehicle limited slip differentials.

### BACKGROUND TO THE INVENTION

When a differential is utilised as part of the power train of a vehicle, the final drive axle, with a wheel at each end, may make either a left or right turn, with the wheel on the outer end of the turn having to turn faster than that on the inner end. The first successful vehicle differential was designed by Onesiphore Pecqueur in 1827. Modern day differentials remain remarkably similar to that original design.

Known differentials for internal combustion and modern electric vehicles comprise a housing containing input gears that mesh with a ring gear. The ring gear drives an inner casing that carries toothed pinions which mesh with right and left side gears connected through half shafts to the respective drive wheels. When the vehicle is driven in a straight line on a flat road, the rotating wheels on either side of the driven axle turn at substantially the same speed causing the pinions to remain generally stationary in the rotating casing. When the vehicle makes a turn, the pinions allow the wheels to rotate at different speeds by rotating at their respective axes in the rotatable casing.

Torque from the input gear is split into two substantially equal components which are distributed substantially equally to the left and right drive wheels. Consequently, if one or other driven wheel rotates because it engages an uneven or slippy surface, such as mud or ice, the driven wheel engaging the slippy surface could spin, whereby the torque applied by that wheel will be reduced if not eliminated. A vehicle fitted with such a differential can, according to circumstances, be immobilized or dangerously uncontrollable on extremely unequal gripping surfaces.

On dry surfaces when a motor vehicle travels around a corner or over uneven surfaces such as when the vehicle turns left or right, or travels in a direction other than a straight line, a relatively small speed difference occurs between the left and right wheels. However, when the vehicle travels on ice, snow, or through mud, the speed differential between the left and right wheels can increase substantially beyond the relatively small speed differences which occur between the wheels on dry pavement. In this instance “slip limitation” is desirable otherwise the vehicle may become immobilized. On the other hand, slip limitation is not desirable in normal driving situations since slip limitation may adversely affect directional control of the vehicle and accelerate tyre wear. Limited slip differentials are known, which limit the speed differentiation or “slip”, so that some of the torque being delivered by the input gear is transferred from the wheel that slips to the wheel that has more traction and therefore, aids in moving the vehicle in the preferred direction.

These limited slip differentials (LSDs) have been developed to overcome the above-mentioned shortcomings of a conventional differential and work on various principles, but generally all are intended to limit the speed difference or “slip” between the left and right driven wheels. However, most of these limited slip differentials do not limit the speed difference between the driven wheels adequately at a substantially large speed differential or slip between the driven wheels. Various known limited slip differentials have friction plates, valves, clutches, pumps, with electronic/electric, hydraulic or pneumatic controls or other special components that not only add to their complexity, but also increase the substantial cost of their production. Energy wasting traction control, by individual wheel braking, is fundamentally fraught with danger if any of its control system malfunctions.

There is a need for a low-cost limited slip differential that limits the speed differentiation or “slip” between the driven wheels and gradually increases torque to the non-slipping wheel as the rotational speed difference between the slipping wheel and the non-slipping wheel increases.

When applied to a motor vehicle, a limited-slip differential should provide slip limitation or torque transfer substantially only when the speed difference between the driven wheels of the motor vehicle is beyond normal driving limits. The torque transfer should increase as the speed difference between the driven wheels increases, and aid in decreasing the probability of a vehicle becoming immobilized during slippery conditions. Torque transfer should be substantially zero or minimal between both driven wheels when there is substantially no speed difference or slip between the driven wheels since such torque transfer is not required. Such limited slip differentials should be: far less expensive; durable; sturdy; easy to manufacture and install, either as an original equipment item or as a retrofit; be capable of having a substantially similar form factor and size as original equipment items; be easy to maintain and require a minimum of maintenance. The limited slip differential should also be compatible with two, four, and multiple drive vehicles, anti-lock braking systems and be usable in other applications, but primarily compatible with electric drive vehicles, where the motor rotor has dual drives, one on each extremity of the rotor shaft, with no requirement of a conventional differential. A progressive limited slip differential being connected to each of the rotor dual drives, the progressive limited slip differentials being further connected via output drive shafts to the road wheels, in effect upgrading even a low-cost vehicle into a superior traction vehicle with only a small financial cost implication.

A few known differentials can have a substantial sealed casing containing a fluid medium with opposing output gears and a plurality of opposing pinions having substantially parallel rotational axes. The opposing pinions, which are normally bevelled gears, mesh one with the other at the medial portions of the opposing pinions in a circumferential manner, and lateral portions of the opposing pinions mesh with opposing output gears, which are affixed to opposing driven shafts. The meshing between opposing pinions one with the other and the meshing between opposing pinions and the opposing output gears respectively, function as gear pumps which pump the fluid medium, in the presence of relative rotation between the opposing output gears. Fluid pressure build-up caused by the pumping action results in pumping resistance and thus slip limitation at the opposing output shafts of the limited slip differential, especially at high rotational speed differences between the opposing output shafts. Partitions substantially centrally located on each opposing pinions provide fluid barriers between the medial and lateral portions of each of the pinions and thus help promote pressure build-up of the pumped fluid medium. However the rotation and layout of the known gears and pinions utilised, tends to churn and so permeate the pumped fluid medium with compressible air bubbles. This entrained air, as it is compressed then released at the mesh points, creates a detrimental sponginess thereby reducing the repeatable effectiveness of the pumping resistance to act as an effective slip limitation irrespective of the number of meshing points that function as gear pumps. Furthermore, compressing any air infused transmission or hydraulic fluid used, causes heat which implies energy use; most known automatic gearboxes requiring separate cooling. Existing types of differentials, limited slip differentials or automatic gearboxes are extremely complex and expensive to manufacture owing to their many different parts and high manufacturing tolerances and have very minimal energy in to energy out losses in the order of 3-7%, the present invention incurring no more than 2%.

It is an object of the present invention to at least partially alleviate the above mentioned disadvantages, or to offer an alternative to existing products. In particular by providing a lighter weight, smaller equivalent sized, far lower cost, simpler to service or maintain limited slip differential than any other currently available on the market; having no sensors, electronic or external controls, no friction plates, springs or separate oil pumps, whilst being capable of meeting or exceeding the current torque standards. To provide in particular, a method whereby the pumped fluid medium is less prone to compressible air bubbles within its working constituency and to further allow the manufacture of a more cost effective and reliable product.

### SUMMARY OF THE INVENTION

The invention provides a progressive limited slip differential as specified in claims 1 to 27 and a limited slip drive as specified in claims 28 to 38.

The use of the word “slip” in reference to the present invention is a misnomer, as it implies the use of energy-consuming clutch like friction plates, whereas the present invention does not incur any significant energy usage/heat production in its automatic gearbox like operation.

Most transmission gear wheels are designed to allow lubrication or hydraulic fluid to escape as their gear teeth mesh in order to minimise drag and allow the gear wheels to turn easily. If the utilised lubrication or hydraulic fluid cannot escape or cannot escape quickly enough, a hydraulic blockage can occur and in normal gearboxes this can lead to serious damage. The present invention aims to deliberately utilize engineered blockages as hydraulic brakes to limit or even virtually prevent the sun and planetary gear wheels rotating within a housing. This is advantageous when embodiments of the invention is used in applications such as a torque convertor or automatic gearbox. The planetary gear wheels of embodiments of the invention can only rotate in order to create a hydraulic blockage if there is a speed difference between the input torque speed and the output torque speed. These blockages however, in most examples, cannot be total. When used as part of a two or four or more wheeled vehicle transmission limited slip differential, as the vehicle is turning, whether short tight corners or long slight curves, the inner road wheels must be capable of turning more slowly than the outer road wheels. Conversely, the outer road wheels must be able to turn faster than the inner road wheels, relative to the radius of the corner the vehicle is driven around, otherwise the vehicle will tend to be propelled in a straight line. The outer drive wheels must be capable of quickly and automatically adjusting to a faster speed compared to the level of drive applied to the inner drive wheels in order that the vehicle can safely navigate the corner. To that end, the tolerances between the planetary gears and their corresponding spacer outward fluid flow passageways (the normal return outward fluid flow passageways) are increased to allow extra leakage from the mesh points back towards the outer casing reservoir. This allows the planetary gear train to spin slightly faster against any outward applied centrifugal force applied to the transmission fluid in order and to enable said transmission fluid to be capable of instantly reducing the mesh point transmission fluid quantity, resulting in greater slip. At the point at which the outer road wheels start to rotate more easily and faster than the inner road wheels, the outer progressive limited slip differential's planetary gears tend to reverse their normal direction, aiding this action and reversing any transmission fluid flow from any filled mesh points, substantially reducing the degree of locking action available and allowing greater “slip” between the outer road wheel and the inner road wheel as required.

Embodiments of the invention comprise a progressive limited slip differential comprising of a housing wherein rotatable gears reside. The housing comprises of a casing within its periphery, which is affixed between at least two generally flat, generally circular first and second plates or plate sets with suitably shaped spacers affixed between. Said spacers further form close fit fluid passageways around the central input sun gear and planetary gear or gears within the housing; said planetary gears having axles which can rotatably engage within top hat shaped plain bearings affixed within the housing outer generally planar end plates. The rotatable housing, with its internal input sun and planetary gears, forms a robust assembly whereby, when a suitable turning motion is applied to the appropriately mounted, lubricated, engaged, input sun and planetary gears, if there was no hydraulic fluid present the planetary gears would rotate freely in their pre-determined direction. Internal spacers closely fitted around the internal planetary gears form fluid flow passageways. In best practice, for balancing and construction strength purposes, a minimum of three equidistantly spaced planetary gears or gear sets are utilised, comprising in one example of inner, intermediate and outer planetary gears. The planetary gears have their central axles rotatably located within top hat shaped, plain planetary gear bearings. Said planetary gear bearing's inner rim faces further act as a face to face mechanical fluid seal between the outer ends of the planetary gear sets and said planetary bearings inner rim face, forming a good fluid seal at the point where the planetary gear teeth fully mesh with each other and the central sun gear in order to largely impede or prevent any transmission fluid contained within the opposing gear teeth mesh points escaping lengthways. The sun gear, has in best practice, a central splined shaft engagement recess for engagement with a known input or output drive shaft. Said sun gear is rotationally held within known bearings further attached within known bearing housings, further attached to one set of outer housing plates. Known oil seals and vacuum seals are further incorporated, utilised to seal in the housing fluid and any vacuum pressure applied. The drive input in the examples illustrated is connected to the sun gear shaft connecting profile and the drive output is via the housing drive shaft connector which is further attached to the opposite outer end plate to that of the drive input. Alternatively, the drive input may be connected to the housing drive shaft connector with the drive output connected to the sun gear drive shaft connector. The sun gear's teeth mesh within the adjoining planetary gear's teeth; any further adjoining planetary gear's teeth meshing as required within further adjoining planetary gear teeth forming a gear train. The outer planetary gears of said gear trains are specifically characterised as having no gear teeth connection with any further outer gear teeth or indeed any further structure, resulting in a situation whereby, if no transmission fluid was evident within the housing and a rotational drive input from a drive source was applied to the sun gear and therefore adjoining planetary gears within said gear train, said planetary gears would be capable of free rotation within said housing with little impetus to turn the housing in a given direction. Conversely, if a rotational drive input from a drive source was applied to the housing and thereby the planetary gear axles, the planetary gears train sets would be capable of free rotation within said housing driven by said planetary gear axles with little impetus to turn the sun gear in a given direction.

When the housing is part filled with transmission fluid to the required level and transmission fluid saturates a mesh point or further mesh points, this would constitute a blockage or near locking action to a degree determined by the tolerances and profiles of the engaged gear teeth mesh points and viscosity of the particular transmission fluid employed. The resultant locking action would be equal to the degree of blockage applied within said mesh points, as the corresponding gear teeth mesh points act as a no outlet known gear pump (not shown) compressing the encompassed transmission fluid within the said mesh points. Said locking action would also be controlled by the amount of transmission fluid continuously available to replenish the mesh points as the sun gear and planetary gears rotate against each other when the turning speed of the sun gear relative to the housing turning speed varies. Any degree of mesh point blockage evident results in the sun gear's teeth locking onto the connected planetary gear's teeth to the equivalent to that of any blockage at any point within the gear train; a minor blockage within the mesh points resulting in more “slip” between the sun gear and housing drives, a major blockage resulting in far less “slip” between the sun gear and housing drives. Any and all blockages within said mesh points being cumulative resulting in a smooth drive sequence. Therefore, any and all mesh point blockages or part blockages inhibiting rotation of the planetary gear train gears' teeth relative to the sun gear's teeth, said planetary gear train gear shafts rotationally driving the housing then always trying to turn at the same speed as the corresponding sun gear when there is little load to reduce the output torque speed. As the housing is mechanically connected to the planetary gears by the planetary gear shafts, the housing is normally driven in the same drive direction as the driven sun gear; conversely, the housing, if driven by the power source, would drive the sun gear according to any blockages within said mesh points.

The housing is in the form of a sealed enclosure. In one example, the central input sun gear having a suitable input shaft for the engagement with a suitable known bearing, oil seal and vacuum seals further mounted within one set of the outer housing end plates. The end of the said input shaft preferably having a corresponding drive profile for engagement with the input sun gear drive profile. The input shaft, or such like, is connected to the power-source or gearbox powered by the power-source (not shown).

In use, the sealed outer housing is specifically only partially filled to a set level with the chosen pumped hydraulic fluid medium hereinafter termed transmission fluid.

Embodiments of the invention may be further characterised in that the sealed housing cavity is subjected to a high level of vacuum during manufacture or servicing, whereby the transmission fluid contained within said housing remains under vacuum and relatively air bubble free at all times as there is virtually no air present within said housing. This effectively eradicates any chance of problematic elastic power absorbing entrained or dissolved air which can further cause cavitation or erosion to the gears and fluid passageways.

Embodiments of the invention may be further characterised in that the rotational deviation of the housing to that of the sun gear is by the mechanical connection of the planetary gear shafts rotationally held within the housing end plates.

Embodiments of the invention may be further characterised by the use of shaped internal spacers which, in conjunction with the robustly attached generally planar first and second end plates form fluid feed passageways adjacent to the gears within the rotatable housing.

Embodiments of the invention may be further characterised in that the fluid flow up the fluid flow passageways to the various meshing gear points is progressive. In normal drive conditions, the outer planetary gear teeth and the outer mesh points with the intermediate planetary gear teeth are suitably immersed in transmission fluid. If the sun gear rotates relative to the outer housing, the planetary gear teeth will act as paddles, gathering the transmission fluid from the centrifugal force transmission fluid reservoir between their open gear teeth roots and the walls of the close fit fluid flow passageways and propelling said transmission fluid towards the central sun gear into the next inner mesh point between opposing planetary gears. The cumulative effect of the resistive or near locking action of the transmission fluid being compressed within the mesh points impedes or stabilizes the difference between the input torque and the output torque speeds. If the combination of the resistive or near locking action of the transmission fluid being compressed within these meshing points is still inadequate to impede the planetary gears rotating relative to the sun gear, the resultant still revolving planetary gears' paddle action will further propel the transmission fluid towards and into any further gear mesh points in order to further increase the resistive or near locking action between the said planetary gears and ergo the housing relative to the sun gear. It will be understood by those skilled in the art that the progressive limited slip differential device could utilise several more or less planetary gears/mesh points according to the requirements of its implementation. The drive input could be applied to the housing making the central sun gear the drive output.

Embodiments of the invention may be further characterised by the creation of a void, or reservoir, adjacent to the housing outer casing periphery. As the progressive limited slip differential is subjected to rotational use, the transmission fluid contained within the sealed housing is subject to substantial corresponding centrifugal forces urging the said transmission fluid outwards into said void or reservoir created. The greater the said centrifugal forces imparted to the transmission fluid, the more any unwanted bubbles of air if sufficient vacuum was not applied within said transmission fluid are substantially expelled, reducing the potential problematic compressibility of a transmission fluid/air mix within the mesh points.

Embodiments of the invention may be further characterised by the use of differing tolerances between the various sets of meshing gear teeth employed, the tolerances being progressively finer and, therefore, the pumping resistance or near locking action being greater, nearer to the centrally disposed sun gear, resulting in a progressive resistive or near locking action between the sun gear and housing within the progressive limited slip differential.

Embodiments of the invention may be further characterised by the capability of their use with differing transmission fluid viscosities according to the application requirement. For greater pumping resistance or near locking action a thicker transmission fluid viscosity should be used, resulting in an equivalent earlier progressive resistive or near locking action between the sun gear and housing within the progressive limited slip differential. This means that one standard progressive limited slip differential can be utilised for several differing purposes by the use of different viscosities of transmission fluid.

Embodiments of the invention may be further characterised in that the maximum coupling speed between the input torque speed and the output torque speed can be preset to suit the required purpose.

Embodiments of the invention further characterised by the fact the progressive limited slip differential can be subjected to substantial rotational speeds in normal use yet the sun gear “slip” relative to the planetary gear train is separately governed by the input torque speed compared to the output torque speed. The planetary gear train seldom turns at any great speed around the sun gear before the saturated mesh points increase the output torque speed towards the input torque speed.

Embodiments of the invention may be further characterised in that when the power is withdrawn or input torque speed is reduced, the progressive limited slip differential can quickly and smoothly work in the opposite direction using the engine or power source as a braking means.

Embodiments of the invention may be further characterised by the layout of the fluid passageways, resulting in different amounts of transmission fluid being fed to the mesh points of the opposing gears. In best practice, when the progressive limited slip differential unit is driven in the reverse direction, the outward fluid passageways used to feed the mesh points in the reverse direction are wider than that of the inward fluid passageways used to feed the mesh points in the normal forward direction, resulting in the planetary gears having to rotate faster to feed the same amount of transmission fluid to the mesh points in the reverse direction, giving dissimilar resistive or locking characteristics in forward and reverse directions.

Embodiments of the invention may be further characterised in that the housing is part filled with transmission fluid to a pre-determined level via an opening and sealed with a plug in order to help define a fluid tight sealing configuration.

Embodiments of the invention may be further characterised by having a minimum of three equally spaced planetary gear teeth or sets of gear trains, so that even at rest, at least one set of outer planetary gears is immersed in transmission fluid, ensuring that there exists at least some initial resistive or locking action within the outer planetary gear mesh point.

Embodiments of the invention may be further characterised in that the power unit comprises of an electric motor incorporating a shaft drive coupling incorporated at each extremity of the electric motor central rotor shaft, said electric motor's rotor shaft incorporating rotor dual drives, one on each extremity of said rotor shaft, a present progressive limited slip differential being connected to each of the rotor dual drives; said progressive limited slip differentials being further connected via output drive shafts to the road wheels; known constant velocity joints (not shown) may also be employed, whilst the use of a conventional expensive differential is unnecessary, thus the drive of an electrically driven vehicle in slippy or off road conditions can be vastly improved at a nominal cost resulting in even budget priced small vehicles being capable of having superior traction.

Embodiments of the invention may be further characterised in that at very low rotational speeds it acts as a reduction gear according to: the amount of transmission fluid available to the mesh points; the viscosity of the transmission fluid employed and the mesh point gear tolerance settings, as at low housing RPMs the transmission fluid has sufficient time to dissipate from the greater tolerance outer mesh points. Existing electric motor drives requiring reduction gearing of up to 8 to 1 in order to overcome their tendency to judder or coggle and overheat at very low rotational speeds.

Embodiments of the invention may be further characterised in that any vehicle's drive axle or other application's, normally incorporating a conventional differential can be replaced by a simple gear with a present progressive limited slip differential being connected to each of the gear dual drive outputs, said progressive limited slip differentials being further connected via conventional output drive shafts to the drive wheels.

Embodiments of the invention may be further characterised in that the seal utilised between the outer casing sealing faces and the corresponding first and second end plate sets is compressible in order to enable optimal service adjustment of the tolerances between the planetary gear planar end surfaces and the planetary gear thrust surfaces, ensuring the minimum lateral leakage from their mesh points.

Embodiments of the invention may be further characterised in that the length of the planetary and sun gears are standardised, normally by a ground finish, and that they and the assembly bolts and fasteners are made from material with the same co-efficient of expansion, in order that as much as possible, the mesh point tolerances do not unduly vary under thermal stresses.

Embodiments of the invention may be further characterised by the use of straight cut gears which are not only the lowest cost to produce but usually require no expensive thrust bearings. As in use the planetary gears seldom rotate much before being impeded there are very little noise implications.

Embodiments of the invention may be further characterised in that when utilised as a method of preventing unwanted mechanical damage to the likes of a driven marine propeller shaft (not shown) when it is suddenly prevented from turning, the various mesh points, incorporate known preset pressure relief valves (not shown) in order to prevent the transmission fluid within said tolerance mesh points causing a detrimental near or absolute blockage.

Embodiments of the invention may be further characterised in that in order to ensure adequate transmission fluid is transmitted to the further inward mesh points as required, various port holes and fluid passageways are incorporated within either or both the housing first and second end plate sets. The end plate sets having port holes and fluid passageways may connect points in advance, or upstream, of the various mesh points.

### BRIEF DESCRIPTION OF THE DRAWINGS

A full and enabling disclosure of the present invention including the best mode thereof, directed to one of ordinary skill in the art, is set forth in the specification which makes reference to the appended drawings, in which:

FIG. 1 is a perspective view of the Progressive Limited Slip Differential illustrating the housing input/output shaft connectors and the vacuum source connection valve.

FIG. 2 is a perspective view of the Progressive Limited Slip Differential illustrating the sun gear input/output drive shaft connectors.

FIG. 3 is a perspective view of the Progressive Limited Slip Differential with the end plates and planetary gear bearings removed (not shown) for illustration purposes, illustrating the sun and planetary gears with their drive axles. The housing is shown wherein the housing drive shaft connector would be upwards.

FIG. 4 is a perspective view of the Progressive Limited Slip Differential with the end plates removed (not shown) for illustration purposes, illustrating the sun and planetary gears with their drive axles. The planetary gear bearings lip rim faces shown sealing the various mesh points. The housing is shown where the housing drive shaft connector would be upwards.

FIG. 5 is a perspective view of the Progressive Limited Slip Differential with the outer and intermediate end plates removed (not shown) for illustration purposes; the planetary gear bearings anti-rotation profiles shown engaged within the inner end plate bearing anti-rotation profiles.

FIG. 6 is a perspective view of the Progressive Limited Slip Differential with the housing second end plate set, the spacers and the outer casing removed (not shown) for illustration purposes. The housing is shown wherein the housing drive shaft connector would have been upwards. The planetary gears are shown within their planetary gear bearings; the central sun gear connected to the planetary gear train.

FIG. 7 is a perspective view of a single planetary gear with its planetary gear bearings and axle.

FIG. 8 is a plan view is of the Progressive Limited Slip Differential with the housing second end plate set removed (not shown) for illustration purposes, further showing the incumbent transmission fluid level when the progressive limited slip differential is being rotated at velocity.

FIG. 9 is a plan view is of the Progressive Limited Slip Differential with the housing second end plate set removed (not shown) for illustration purposes. The progressive limited slip differential shown as if it was stationary; the incumbent transmission fluid level at rest illustrated.

FIG. 10 is a plan view is of the Progressive Limited Slip Differential with the housing second end plate set removed (not shown) for illustration purposes. The progressive limited slip differential shown as if it was being rotated at velocity; the incumbent transmission fluid level during rotation illustrated. The transmission fluid spacer inward fluid flow passageways and all mesh points being shown filled with transmission fluid as an illustration of the inward transmission fluid flow. The drive input applied to the sun gear.

FIG. 11 is a plan view is of the progressive limited slip differential with the housing second end plate set removed (not shown) for illustration purposes. The progressive limited slip differential shown as if it was being rotated at velocity; the incumbent transmission fluid level during rotation illustrated. The transmission fluid spacer outward fluid flow passageways and all mesh points being shown filled with transmission fluid as an illustration of the outward transmission fluid flow, the drive input applied to the sun gear.

FIG. 12 is a plan view is of the progressive limited slip differential with the housing second end plate set removed (not shown) for illustration purposes. The progressive limited slip differential shown having only two planetary gears in each planetary gear train; the possible compactness of the progressive limited slip differential illustrated.

FIG. 13 is a schematic illustration of the progressive limited slip differentials fitted to a four wheel drive vehicle whose wheels are straight.

FIG. 14 is a schematic illustration of the progressive limited slip differentials fitted to a four wheel drive vehicle whose wheels are turning a corner.

FIG. 15 shows the progressive limited slip differential, dismantled into its constituent parts for display purposes.

FIG. 16 illustrates the progressive limited slip differential whereas the various end plates incorporate transfer ports and transfer channels which assist the flow of transmission fluids to further mesh points.

FIG. 17 is a schematic illustration of two progressive limited slip differentials fitted to a dual ended single electric motor driven, front or rear wheel drive vehicle. The power unit comprises of an electric motor; said electric motor's known rotor shaft incorporating rotor dual drives (not shown), one on each end of the motor rotor shaft, a progressive limited slip differential being connected to the extremity of each end of said rotor shafts; said progressive limited slip differentials being further connected via the output drive shafts to the driven road wheels.

FIG. 18 Illustrates a dual drive electric motor whereas the central rotor shaft incorporates rotor dual drives, one on each extremity of said rotor shaft.

Among those benefits and improvements that have been disclosed, other objects and advantages of the invention will become apparent from the following description taken in conjunction with the accompanying drawings.

### REFERENCE TO THE DRAWINGS

The following is a listing of the various components used in the best mode preferred embodiment and alternative embodiments. For the ready reference of the reader the reference numerals have been arranged in ascending numerical order.

1/Progressive Limited Slip Differential
200/Housing
201/Outer Casing
202/Outer Casing assembly holes
203/Outer Casing Compressible Seal Groove
204/Outer Casing Compressible Seal
205/Outer Casing Outer Wall
206/Outer Casing Inner Wall
301/Housing First End Plate Set
302/Housing Second End Plate Set
303/Inner End Plate
304/Inner End Plate Bearing Lip Recess
305/Inner End Plate Lip Anti-Rotation profile
306/Outer End Plate
307/Intermediate End Plate
308/End Plate Bolt Holes
309/End Plate Location Pin Holes
310/Housing Drive Shaft Connector
311/End Plate Port Holes
312/End Plate First Fluid Channels
313/End Plate Second Fluid Channels
314/Vacuum Source Connection Valve
400/Spacers
401/Spacer Fluid Passageway Walls
402/Spacer Inward Fluid Flow Passageway
403/Spacer Outward Fluid Flow Passageway
500/Sun Gear
501/Sun Gear Teeth
502/Sun Gear Teeth Profiles
503/Sun Gear Teeth Roots
504/Sun Gear Teeth Mesh Points
505/Sun Gear Shaft
506/Sun Gear Drive Shaft Connector Profile
507/Sun Gear Shaft Bearing
508/Sun Gear Shaft Oil Seal
509/Sun Gear Shaft Housing
600/Planetary Gears
601/Planetary Gear Teeth
602/Planetary Gear Teeth Profiles
603/Planetary Gear Teeth Roots
604/Planetary Gear Axle Bores
605/Planetary Gear Axles
606/Inner Planetary Gears
607/Intermediate Planetary Gears
608/Outer Planetary Gears
609/Planetary Gear Mesh Point
610/Planetary Gear Lateral Planar Surfaces
611/Planetary Gear Bearings
612/Planetary Gear Bearing Thrust Surface
613/Planetary Gear Bearing Lip Rim Face
614/Planetary Gear Bearing Anti-Rotation Profile
615/Planetary Gear Train
616/Planetary Gear Train Sets
700/Assembly Bolts
701/Assembly Fasteners
702/Location Pins
800/Transmission Fluid
801/Transmission Fluid Centrifugal Reservoir
802/Transmission Fluid Level At Rest
803/Transmission Fluid Level During Rotation
900/Power Unit
901/Direction Gearbox
902/Road Wheels
903/Drive Shafts
904/Dual Drive Electric Motor
905/Electric Motor Rotor Shaft
906/Electric Motor Rotor Shaft Dual Drives
907/Stator Housing
ITS/Input Torque Speed
OTS/Output Torque Speed
DI/Drive Input
DO/Drive Output
D Forward Drive Direction
R Reverse Direction

### DETAILED DESCRIPTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore specific structural and functional details disclosed herein are not to be interpreted as being limiting, but merely as a basis for the claims and as one skilled in the art to variously employ the invention.

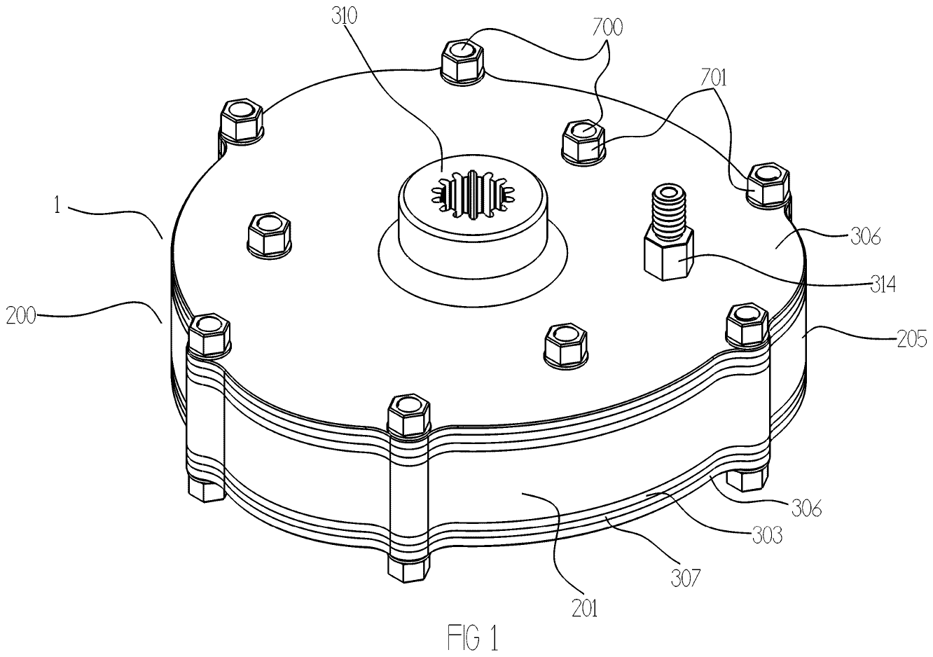

FIGS. 1 to 18 show a progressive limited slip differential 1 comprising a housing assembly comprising a housing 200 that houses a rotatable sun gear 500 and a plurality of planetary gears 600. The housing 200 comprises an outer casing 201, which defines an outer periphery of the housing, and at least two generally flat, generally circular first and second plates end plate sets 301, 302 that cover the respective ends of the outer casing 201. The housing assembly further comprises suitably shaped spacers 400 disposed within the outer casing 201 between the first and second end plate sets 301, 302. The spacers 400 are configured to form close fit inward and outward fluid flow passageway 402, 403 walls 401, around the central sun gear 500 and planetary gear or gears 600 within the housing 200. The planetary gears 600 have axles 605 which can rotatably engage within top hat shaped planetary gear bearings 611 rotationally affixed within the housing 200. The planetary gear bearings 611 are fixed against rotation to the generally planar inner end plates 303 of the first and second end plate sets 301, 302. The drive input DI in the examples illustrated is connected to the sun gear drive shaft connector profile 506 and the drive output DO is via the housing drive shaft connector 310. The drive shaft connector 310 is attached to the outer end plate 306 opposite to that of the drive input DI. The drive input DI is optionally capable of being connected to the housing drive shaft connector 310 and the drive output DO connected to the sun gear shaft 505. The housing 200 with its internal sun and planetary gears 500, 600, form a robust assembly with the planetary gear bearings lip rim faces 613 acting as face to face mechanical fluid seals between the planetary gear bearing thrust surfaces 612 of the planetary gears lateral planar surfaces 610 and the planetary bearings inner lip rim face 613, forming a good fluid seal at the point where the planetary gear teeth 601 create a mesh point 609, 504 with each other and the central sun gear 500 in order to largely impede or prevent any transmission fluid 800 contained within said opposing gear teeth mesh points 504, 609 escaping laterally. The sun gear 500 is rotationally held within known gear shaft bearings 507 further attached within a known, sun gear shaft housing 509, further attached to an outer end plate 306. Known vacuum/oil seals 508 are utilised to seal in the transmission fluid 800. The teeth 501 of the sun gear 500 interengage the adjoining teeth 601 of the planetary gears 600. any further adjoining planetary gear's teeth 601, interconnecting as required, within further adjoining planetary gear teeth 601, forming as required, a planetary gear train 615. The outer planetary gears 608 of said planetary gear trains 615 are specifically characterised as having no gear teeth 601 connection with any further outer gear teeth 601 or indeed any further structure, resulting in a situation whereby, if no transmission fluid 800 was evident within the housing 200 and a rotational drive input from a drive source was applied to the sun gear 500 and therefore adjoining planetary gears 600, within said gear train 615, said gear train 615 gear teeth 601 would be capable of free rotation within said housing 200 with little impetus to turn the housing 200 in a given forward or reverse drive direction D, R. Conversely, if a known rotational drive input DI from a known drive source was applied to the housing 200 and thereby the planetary gear axles 605, the planetary gears train sets 615 would be capable of free rotation within said housing 200 driven by said planetary gear axles 605 with little impetus to turn the sun gear 500 in a given forward or reverse drive direction D, R.

When transmission fluid 800 saturates any mesh point 609 or further planetary gears 600 or planetary gears 600 to sun gears 500 mesh points 609, 504, this constitutes a blockage or near locking action to a degree determined by the tolerances between the sun and planetary gear teeth profiles 502, 602; said engaged gear teeth 501, 601, mesh points 504, 609; and the viscosity of the particular transmission fluid 800 employed. The resultant near locking action would be equal to the degree of blockage applied within said mesh points 609, 504 compressing the encompassed transmission fluid within said mesh points 609, 504. The said locking action would be also be further controlled by the amount of transmission fluid 800 continuously available to replenish said mesh points 609, 504 as the sun gear and planetary gears 500, 600 rotate against each other when the input torque speed ITS of the sun gear 500 relative to the housing 200 output torque speed OTS varies. Any degree of mesh point 609, 504 blockage evident results in the sun gear's 500 teeth 501 locking onto the connected planetary gear's 600 gear teeth 601 to the equivalent to that of any blockage at any point within the planetary gear train 615; a minor blockage within the mesh points 609, 504 resulting in more “slip” between the sun gear 500 and housing 200 input and output drives DI, DO; a major blockage resulting in far less “slip” between the sun gear 500 and housing 200 input and output drives DI, DO. Any and all blockages within said mesh points 609, 504 being cumulative resulting in a smooth drive sequence. Therefore any and all mesh point 609, 504 blockages or part blockages inhibit rotation of the planetary gear train 615 relative to the sun gear 500. The planetary gear train 615, planetary gear axles 605 are always trying to turn at the same speed as the corresponding sun gear 500 input torque speed ITS when there is little load to reduce the output torque speed OTS. As the housing 200 is mechanically connected to the planetary gears 600 by the planetary gear axles 605, the housing 200 is normally driven in the same forward or reverse drive direction D, R as the driven sun gear 500.

Conversely, the housing 200, if driven by the power unit 900, would drive the sun gear 500 according to any blockages within said mesh points 609, 504. Any near locking action caused by the encapsulation or semi encapsulation of said transmission fluid 800 within said planetary and sun gear teeth mesh points 609, 504 provides a progressive locking action between the central, sun gear 500 and the housing 200 assembly. The output torque speed OTS always tries to adjust to the input torque speed ITS, when the rotational deviation between the sun gear 500 relative to the housing 200 turning speed varies. The planetary gear or gears 600 will therefore turn within said housing 200, feeding transmission fluid 800 inwards to more central, mesh points 609, each additional mesh point 609, 504 as it is filled with said transmission fluid, creates an additional impedance or blockage and therefore reduces any rotational deviation between said housing 200 and sun gear 500 input torque speed ITS and output torque speed OTS. If there is little or no rotational deviation, there is less or no feeding of transmission fluid 800 to further mesh points 609, 504, as there is less or no requirement for it. The progressive limited slip differential 1 can be configured by its chosen value of transmission fluid 800 viscosity and its planetary gear mesh points 609, 504 tolerances to have almost limitless pre-ordained settings and therefore, almost limitless pre-ordained levels of rotational deviation, or lack of it, between said housing 200 and sun gear 500 input torque speed ITS and the housing drive shaft connector 310 output torque speed OTS.

As the progressive limited slip differential 1 can be subjected to considerable rotational velocity, the transmission fluid 800 contained within the sealed housing 200 will be subject to the same substantial corresponding centrifugal forces urging the used said transmission fluid 800 outwards into the transmission fluid centrifugal reservoir 801 created. When the housing 200 is rotating, the contained transmission fluid 800 is spun by the applied centrifugal force to a degree corresponding to the rotating housing 200 velocity. The transmission fluid 800 is being spun towards the transmission fluid outer centrifugal reservoir 801, giving a transmission fluid level during rotation 803 adjacent the outer casing inner wall 206; said centrifugal force further compressing said transmission fluid 800 therein, squeezing out entrained bubbles from said transmission fluid 800, reducing the potential problematic compressibility of a transmission fluid 800/air mix within the mesh points 609, 504, resulting in less or no aerated compression of the transmission fluid 800 utilised within the mesh points 504, 609. As air free hydraulic transmission fluid 800 is generally non compressible, it does not heat up when continually compressed or released. However, said transmission fluid 800 is in contact with a proportionally large housing 200 surface area which when the correct materials are used, ensures good heat dissipation and ambient heat transfer, helping to provide a stable transmission fluid 800 temperature.

A progressive limited slip differential 1 wherein the sealed housing 200 cavity during manufacture or servicing prior to use, is subjected to a high level of vacuum wherein the transmission fluid 800 contained within said housing 200 centrifugal reservoir 801 remains under vacuum and essentially air bubble free at all times as there is virtually no air present within said housing 200.

A progressive limited slip differential 1 wherein the tolerances between the opposing planetary gear teeth 601 or between the sun gear teeth 501 and planetary gear teeth 601 have progressively tighter tolerances within the planetary gear mesh points 609; the nearer they are to the sun gear mesh points 504, the tighter the meshing tolerances between said planetary and or sun gear teeth 601, 501, creating a greater degree of blockage or impedance to any rotation of said planetary gears 600 when said planetary gear mesh point or points 609 are part filled or filled with transmission fluid 800. The outer planetary gear 608 mesh points 609 being the first to be filled with transmission fluid 800, create the least degree of blockage or impedance. The intermediate planetary gear 607 mesh points 609, being the next to be filled, creating a greater degree of blockage or impedance; the inner planetary gears 606 to sun gears 500 mesh points 504 when filled with transmission fluid creating a far greater degree of blockage or impedance. The degree of planetary gear or sun gear mesh points 609, 504 blockage or impedance is cumulative, effectively spreading the impeding or near locking function over the entire planetary gear train sets 616 and thereby all the planetary gear axles 605.

A progressive limited slip differential 1 wherein the outer casing compressible seal groove 203 and the inner end plate 303 of the corresponding first and second end plate sets 301, 302, enables adjustment of the tolerances between the planetary gear lateral planar surfaces 610 and the planetary gear bearing thrust surfaces 612, ensuring the minimum lateral leakage from their mesh points 504, 609.

A progressive limited slip differential 1 wherein the housing 200 is only part filled with transmission fluid 800 to a set level whereby even the transmission fluid level at rest 802 saturates a planetary gear mesh point 609 or further planetary gear mesh points 609. This would constitute an initial blockage or locking action to a degree determined by the tolerances and profiles 602, 502 of the engaged planetary 600 or sun 500 gear teeth mesh points 609, 504 and the viscosity of the particular transmission fluid 800 employed.

A progressive limited slip differential 1 wherein when the centrifugal reservoir 801 has the outer planetary gear 608 gear teeth 601 immersed within its transmission fluid 800, any gear teeth 601 rotation acts like a paddle wheel. When said housing 200 is rotated, any centrifugal forces thereby implemented tend to be project said transmission fluid 800 contained within said housing 200 towards the outer casing inner wall 206 thereby creating a deliberate transmission fluid centrifugal reservoir 801 adjacent to the outer casing inner wall 206; the deepest point of said transmission fluid centrifugal reservoir 801 being located adjacent to the outer planetary gear 608. When there is a rotational deviation between the sun gear 500 and the housing 200, the entrained planetary gears 600 will be caused to rotate. As the outer planetary gears 608 are adjacent the deepest point of said transmission fluid centrifugal reservoir 801, any entrained transmission fluid 800 can be carried, as in the example illustrated and dependent on the direction of rotation, up the spacer inward fluid flow passageways 402, returning back via the outward fluid flow passageways 403 to the transmission fluid centrifugal reservoir 801.

FIG. 1 is in particular a perspective view of the Progressive Limited Slip Differential 1 further illustrating the housing input/output shaft connector 310 attached to the outer end plate 306. The assembly bolts and fasteners 700, 701 are further shown clamping the housing 200 closed. The housing first and second end plate sets 301,302 are shown as inner, intermediate and outer end plates 303, 307 and 306 assembled in a laminate like manner. Further shown is a known vacuum source connection valve 314.

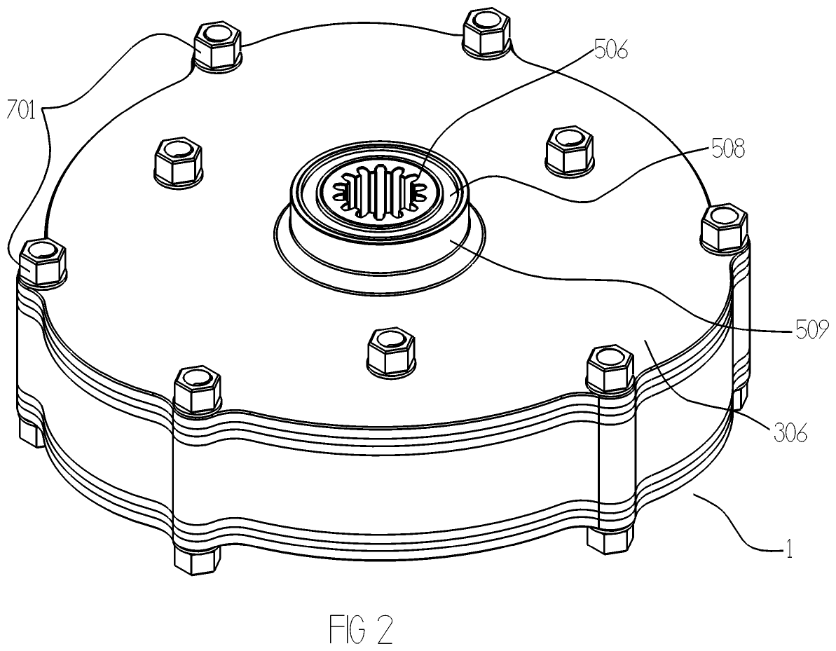

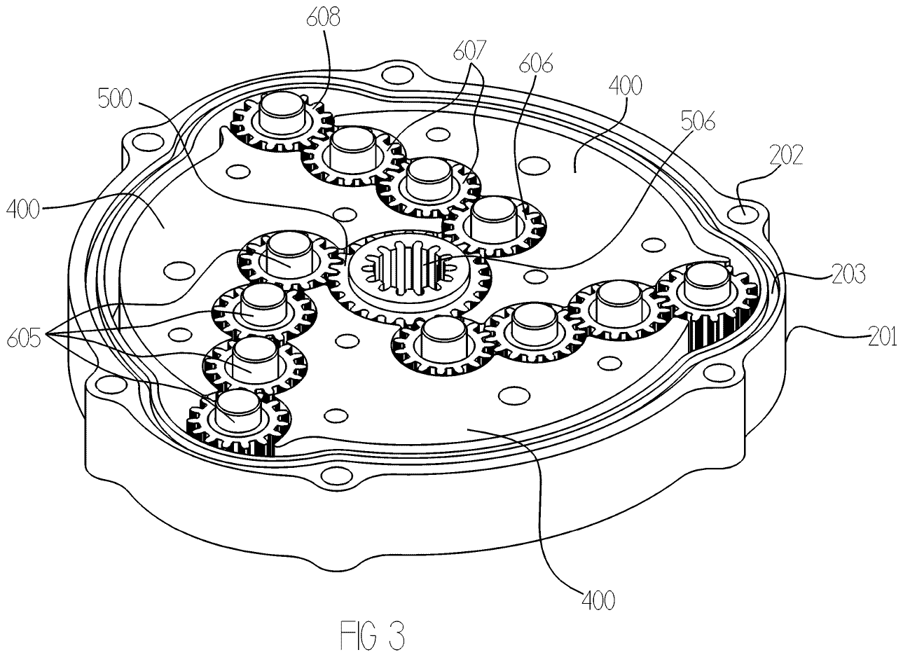

FIG. 2 is in particular a perspective view of the progressive limited slip differential 1 further illustrating the sun gear input/output shaft connector profile 506 and known oil/vacuum seal 508. FIG. 3 in particular is a perspective view of the progressive limited slip differential 1 with the first and second end plate sets 301, 302 and planetary gear bearings 611 removed (not shown) for illustration purposes, illustrating the sun 500 and inner, intermediate and outer planetary gears 606, 607 and 608 with their drive axles 605 within the spacers 400. The housing outer casing 201 is shown whereas the housing drive shaft connector 310 would have been upwards.

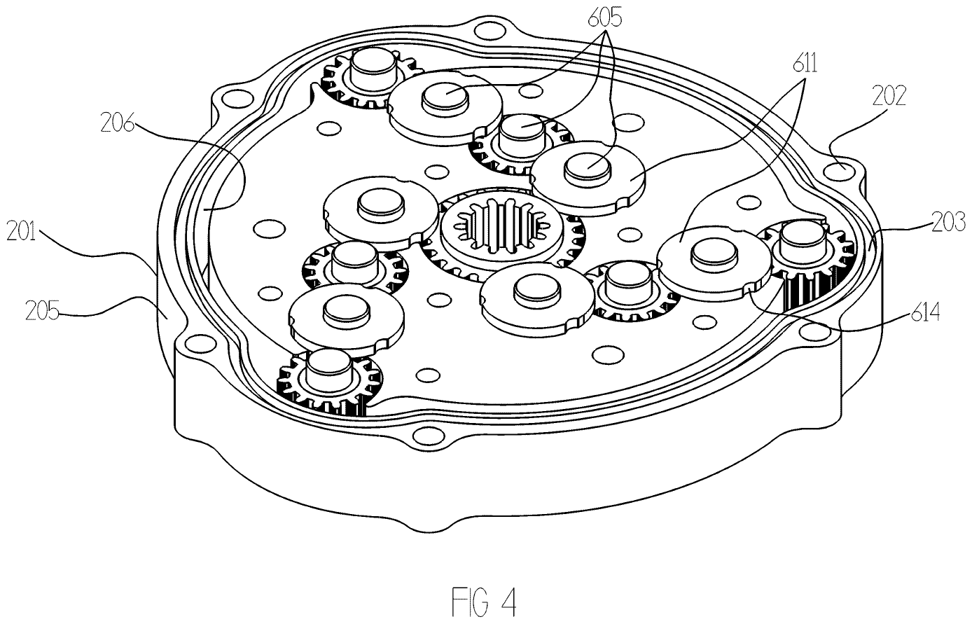

FIG. 4 is a perspective view of the progressive limited slip differential 1 with the first and second end plate sets 301, 302 removed (not shown) for illustration purposes, illustrating the sun and planetary gears with their drive axles. The planetary gear bearings lip rim faces 613 sealing the various sun and planetary gear mesh points 504, 609. The outer casing 201 is shown whereas the housing drive shaft connector 310 would have been upwards.

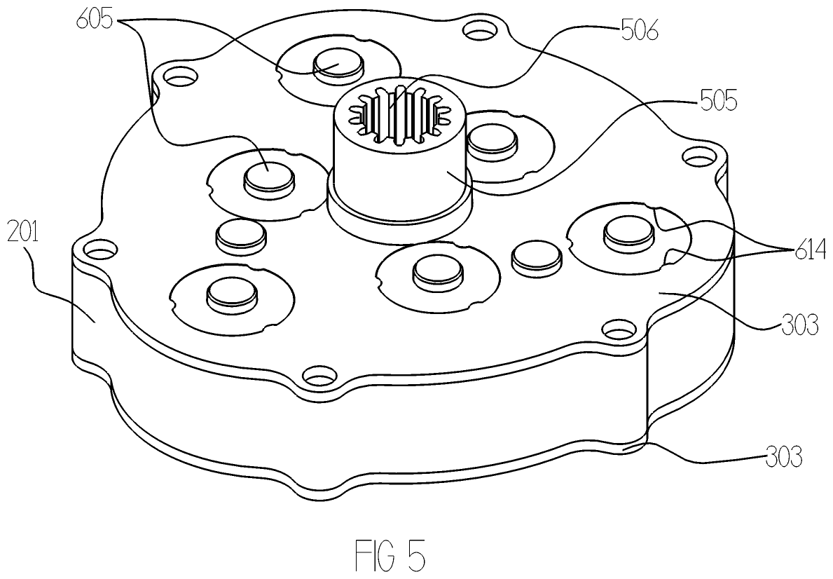

FIG. 5 is a perspective view of the progressive limited slip differential 1 with the outer and intermediate end plates 301, 302 removed (not shown) for illustration purposes, the planetary gear bearings anti-rotation profiles shown 614 engaged within the inner end plate bearing lip anti-rotation profiles 305.

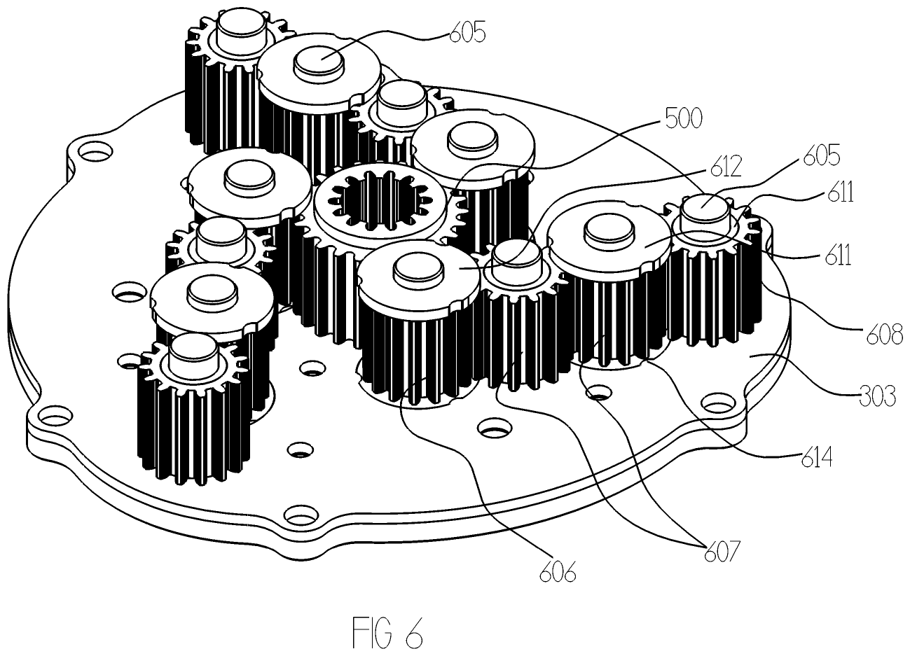

FIG. 6 is a perspective view of the progressive limited slip differential 1 with the housing second end plate set 302, the spacers 400 and the outer casing 201 removed (not shown) for illustration purposes. The housing 200 is shown whereas the housing drive shaft connector 310 would have been upwards. The planetary gears 600 are shown within their planetary gear bearings 610, the central sun gear 500 shown connected to the planetary gear train 615.

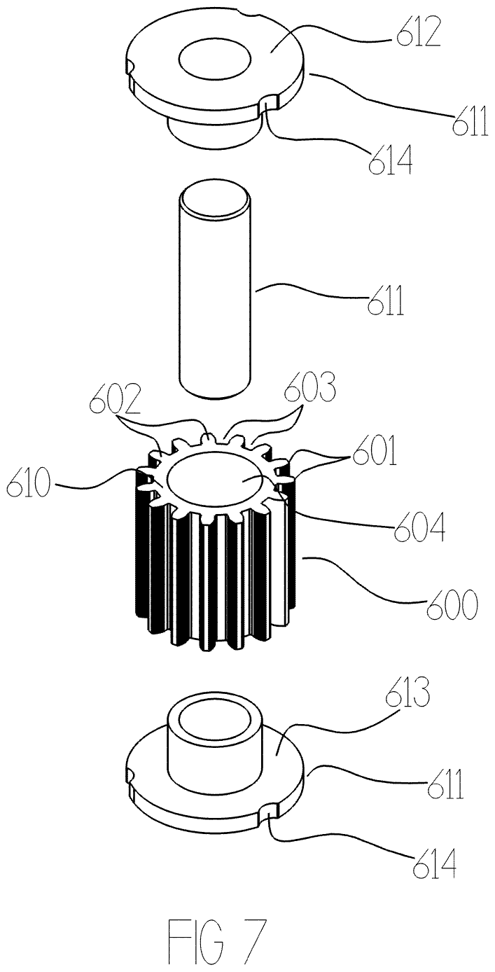

FIG. 7 is a perspective view of a single planetary gear 600 incorporating, gear teeth 601, gear teeth profiles 602, teeth roots 603, axle bores 604 and lateral planar surfaces 610 with its planetary gear bearings 611 having an inner lip rim face 613 and outer thrust surface 612, further illustrated is the planetary gear axle 605.

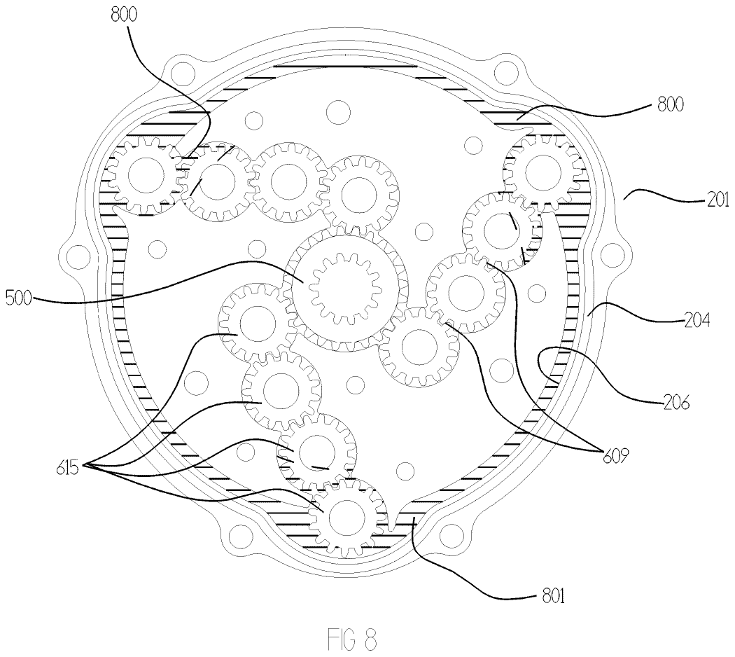

FIG. 8 is a plan view is of the progressive limited slip differential 1 with the housing second end plate set 302 removed (not shown) for illustration purposes. The progressive limited slip differential 1 shown as if it was being rotated at velocity, the incumbent transmission fluid level illustrated during rotation 803.

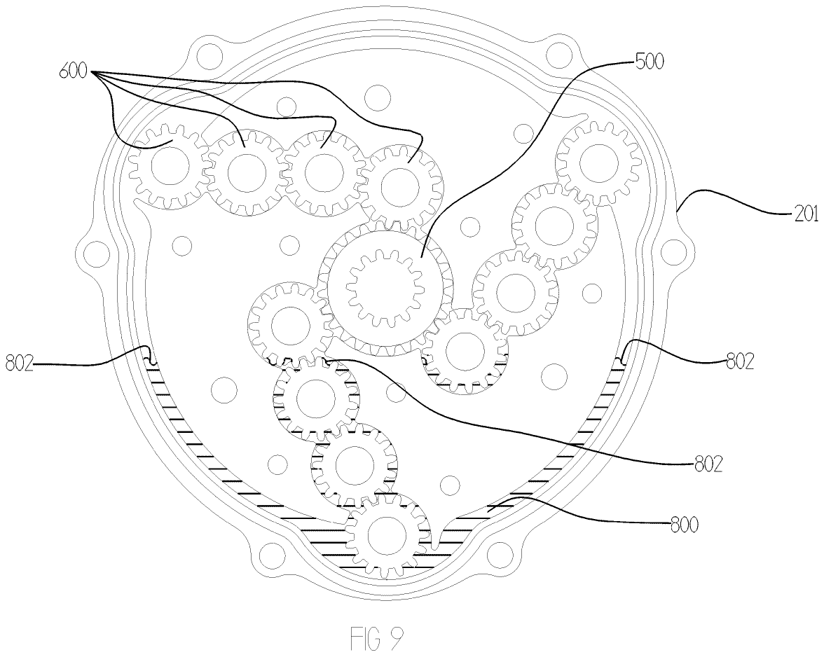

FIG. 9 is a plan view is of the progressive limited slip differential 1 with the housing second end plate set 302 removed (not shown) for illustration purposes. The progressive limited slip differential 1 shown as if it was stationary; the incumbent transmission fluid 802 level, illustrated at rest.

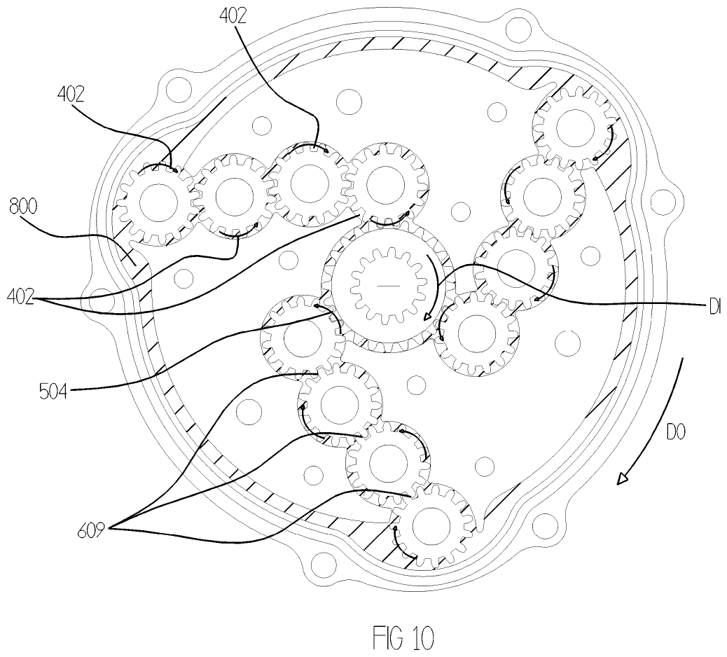

FIG. 10 is a plan view is of the progressive limited slip differential 1 with the housing second end plate set 302 removed (not shown) for illustration purposes. The progressive limited slip differential 1 shown as if it was being rotated at velocity; the incumbent transmission fluid level illustrated during rotation 803. The transmission fluid 800 spacer 400 inward fluid flow passageways 402 and all mesh points 504, 609 being shown filled with transmission fluid 800 as an illustration of the inward transmission fluid flow passageway 402 fluid flow. The drive input DI applied to the sun gear 500.

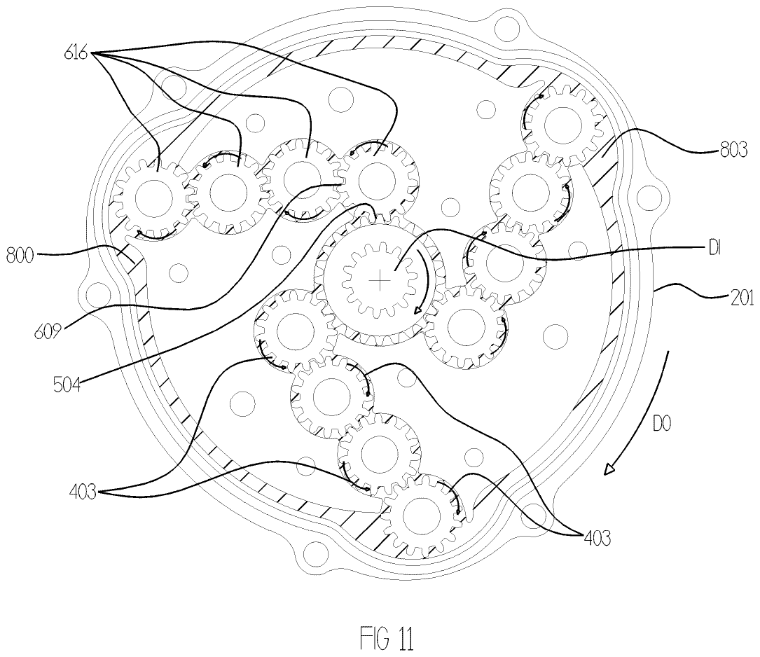

FIG. 11 is a plan view is of the progressive limited slip differential 1 with the housing second end plate set removed 302 (not shown) for illustration purposes. The progressive limited slip differential 1 shown as if it was being rotated at velocity; the incumbent transmission fluid level illustrated during rotation 803. The transmission fluid 800 spacer 400 outward fluid flow passageways 403 and all mesh points 504, 609 being shown filled with transmission fluid 800 as an illustration of the spacer outward transmission fluid flow passageway 403 fluid flow. The drive input DI applied to the sun gear 500.

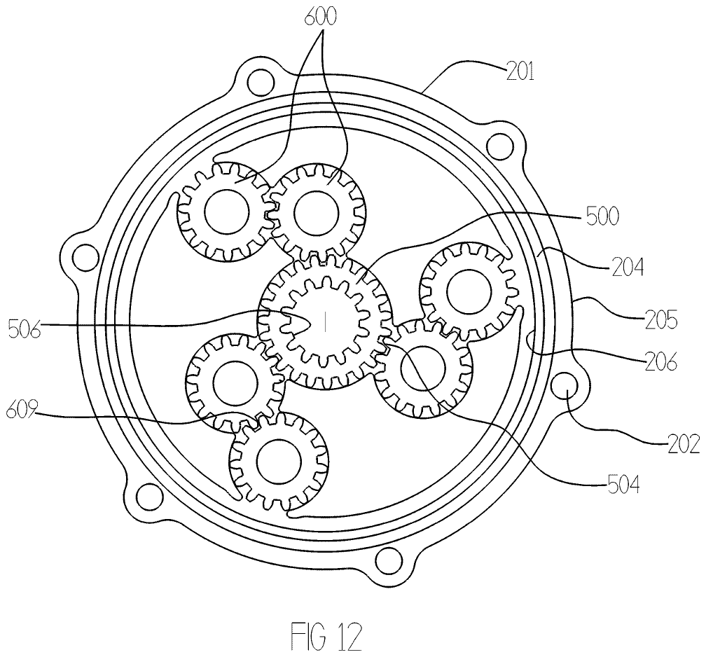

FIG. 12 is a plan view is of the progressive limited slip differential 1 with the housing 200 second end plate set 302 removed (not shown) for illustration purposes. The progressive limited slip differential 1 example shown having only two planetary gears 600 in each planetary gear train 615; the possible compactness of the progressive limited slip differential 1 illustrated.

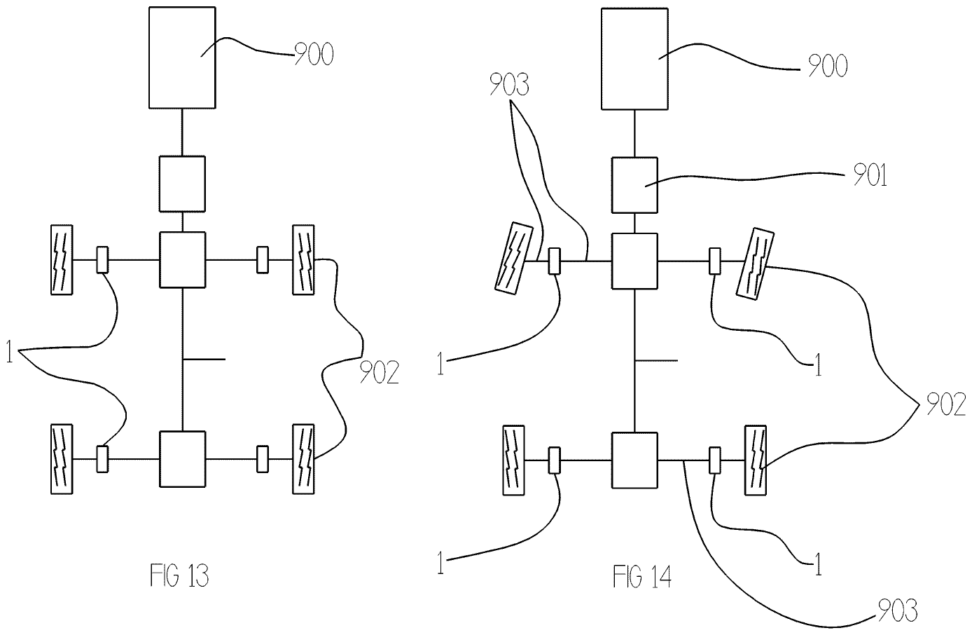

FIG. 13 is a line drawing of the progressive limited slip differentials 1 fitted to a four wheel drive vehicle, whose wheels 902 are straight. The vehicle drive shafts 903, direction gearbox 901 and power unit 900 are further shown.

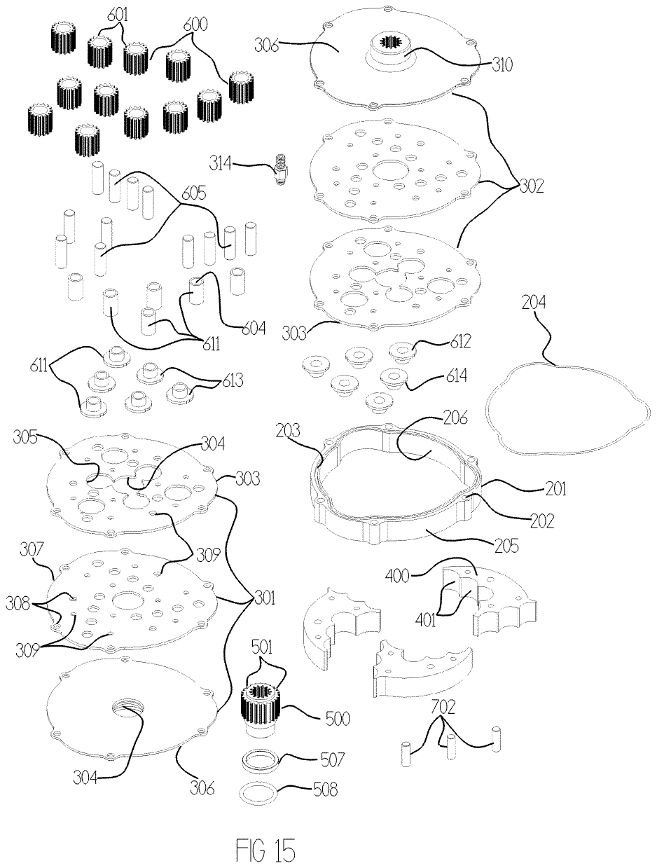

FIG. 14 is a schematic illustration of the progressive limited slip differentials 1 fitted to a four wheel drive vehicle, whose wheels 902 are turning a corner.

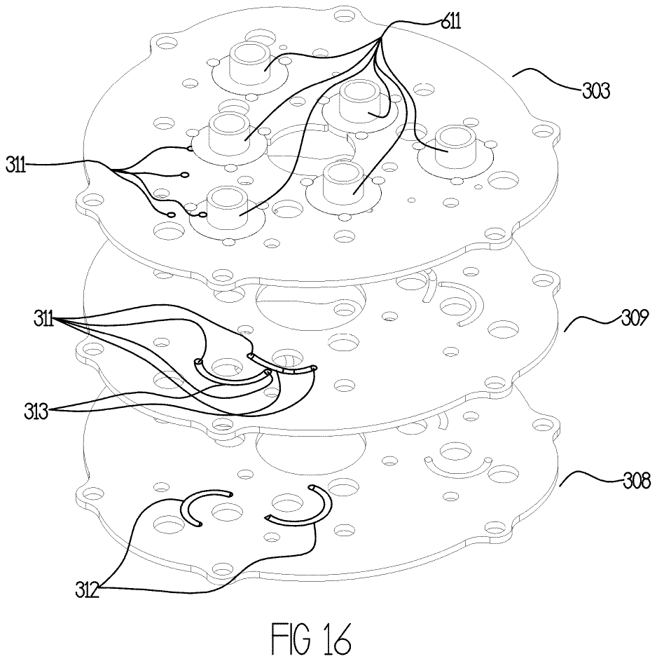

FIG. 15 shows the housing first or second end plate set 301, 302, dismantled into their constituent individual inner end plate 303, intermediate end plate 309 and outer end plate 308 parts for display purposes, wherein in order to further ensure adequate transmission fluid 800 is transmitted to the progressively inward mesh points 609, 504 as required, various end plate port holes 311 and first and second fluid channels 312, 313 are incorporated within either or both the housing first and second end plate sets 300, 301, said end plate sets 300, 301 having the end plate port holes 311 and end plate first and second fluid channels 312, 313 connecting points just before the mesh points 609, 504 inward transmission fluid 800 flow mesh points 609, 504 in their inward flow and exiting within a point within the spacer inward fluid flow passageway 402 before the next inward transmission fluid 800 flow mesh points 609, 504.

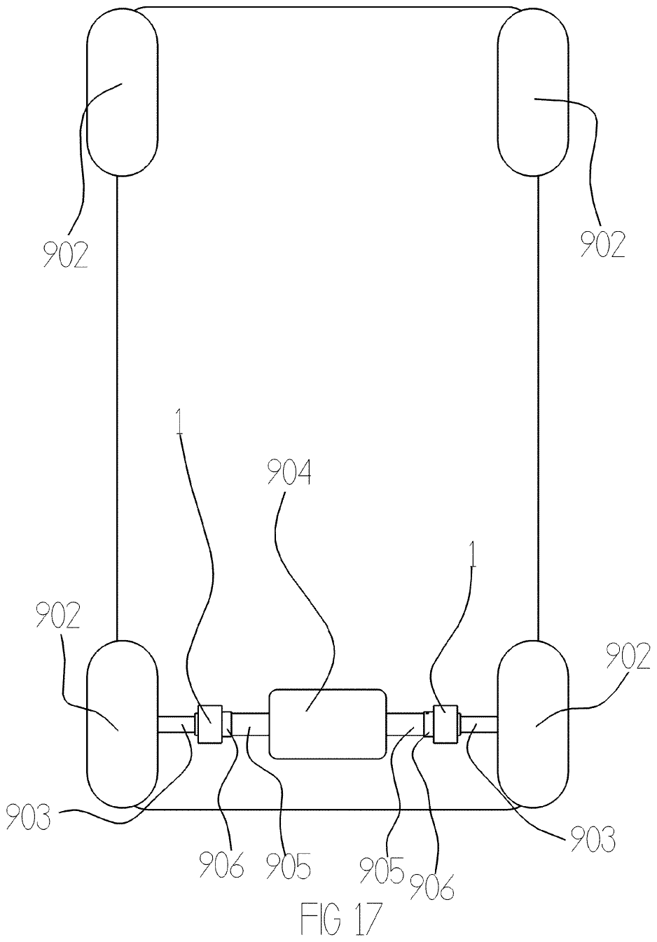

FIG. 16 shows an example of a first or second end plate set 301, 302 configured to provide one of more flow passages to convey the transmission fluid 800 progressively inward mesh points 609, 504. Various end plate port holes 311 and first and second fluid channels 312, 313 are incorporated within the end plates of either or both the housing first and second end plate sets 300, 301 connecting points just before the mesh points 609, 504. In the illustrated example, the first and second fluid channels 312, 313 comprise arcuate grooves defined in a surface of the intermediate end plate 307 and outer end plate 306.

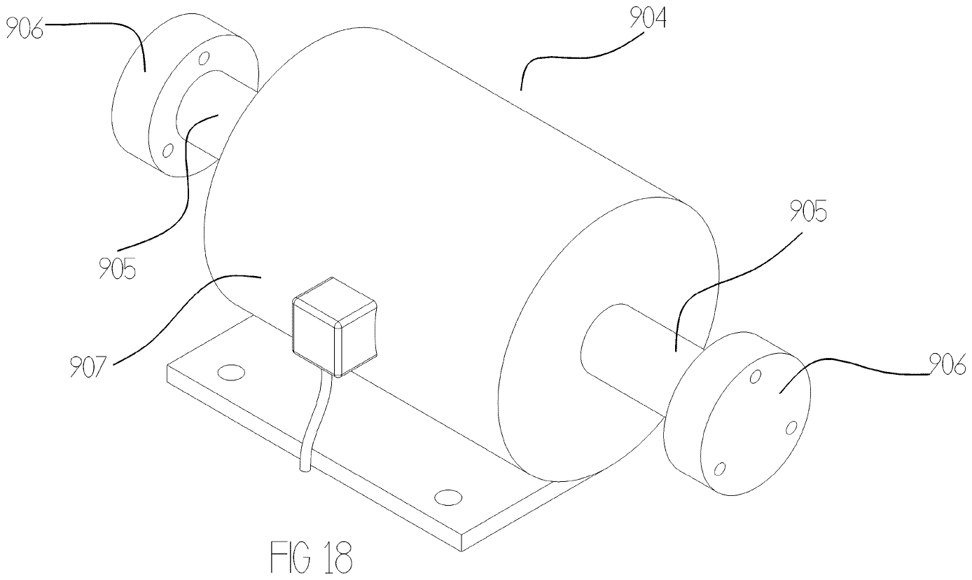

FIG. 17 is a schematic illustration of respective progressive limited slip differentials 1 fitted to a single drive axle vehicle. The power unit used is a dual ended single electric motor 904 powering, in the example illustrated, a front or rear wheel 902 drive vehicle. The rotor shaft 905 of the electric motor 904 incorporates rotor dual drives 906, one on each end of the motor rotor shaft 905. The outer end of each rotor dual drive 906 is connected with a progressive limited slip differential 1. Each progressive limited slip differential 1 is connected via a output drive shaft 903 to the respective driven road wheel 902.

FIG. 18 Illustrates in perspective, the dual drive electric motor 904. The central rotor shaft 905 is shown provided with rotor dual drives 906, one on each end of the rotor shaft 905. The motor stator 907 is also shown.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

1. A progressive limited slip differential 1 comprising a housing 200 wherein rotatable sun and planetary gears 500, 600 reside;
said housing 200 further comprises within its periphery, of an outer casing 201 which is affixed between; at least two generally flat, generally circular first and second end plates or end plate sets 301, 302 with suitably shaped spacers 400 affixed between; said spacers 400 further form close fit inward and outward fluid flow passageways 402, 403 around the central sun gear 500 and planetary gear or gears 600 within said housing 200; said planetary gears 600 having axles 605 which can rotatably engage within top hat shaped, planetary gear bearings 611 affixed within the housing 200 generally planar, inner end plates 303; the drive input DI in the examples illustrated being connected to the sun gear shaft connector profile 506, the drive output DO is via the housing drive shaft connector 310 which is further attached to the opposite outer end plate 306 to that of the drive input DI, which is optionally capable of being connected to the housing drive shaft connector 310 and the drive output DO connected to the sun gear shaft 505; said housing 200, with its internal sun and planetary gears 500, 600, forming a robust assembly wherein planetary gear bearings lip rim faces 613 further act as a face to face mechanical fluid seal between the planetary gear bearing thrust surfaces 612 of the planetary gear lateral planar surfaces 610 and said planetary bearings inner lip rim face 613, forming a good fluid seal at the point where the planetary gear teeth 601 create a mesh point 609, 504 with each other and the central sun gear 500 in order to largely impede or prevent any transmission fluid 800 contained within said opposing gear teeth mesh points 504, 609 escaping latterly; said sun gear 500 rotationally held within known gear shaft bearings 507 further attached within a known sun gear shaft housing 509, further attached to an outer end plate 306; known vacuum/oil seals 508 are further incorporated, utilised to seal in the transmission fluid 800;
the sun gear's teeth 501 interconnect within the adjoining planetary gear's teeth 601; any further adjoining planetary gear's teeth 601 interconnecting as required within further adjoining planetary gear teeth 601 forming a planetary gear train 615; the outer planetary gears 608 of said planetary gear trains 615 are specifically characterised as having no gear teeth 601 connection with any further outer gear teeth 601 or indeed any further structure, resulting in a situation whereby, if no transmission fluid 800 was evident within the housing 200 and a rotational drive input from a drive source was applied to the sun gear 500 and therefore adjoining planetary gears 600, within said gear train 615, said gear train 615 gear teeth 601 would be capable of free rotation within said housing 200 with little impetus to turn the housing 200 in a given forward or reverse drive direction F, D; conversely, if a known rotational drive input DI from a known drive source was applied to the housing 200 and thereby the planetary gear axles 605, the planetary gears train sets 616 would be capable of free rotation within said housing 200 which is driven by said planetary gear axles 605 with little impetus to turn the sun gear 500 in a given forward or reverse drive direction F, D;
when transmission fluid 800 saturates any mesh point 609 or further planetary gears 600 or planetary gears 600 to sun gears 500 mesh points 609, 504, this would constitute a blockage or near locking action to a degree determined by the tolerances and sun and planetary gear teeth profiles 502, 602 of said engaged gear teeth 501, 601 mesh points 504, 609 and the viscosity of the particular transmission fluid 800 employed; the resultant near locking action would be equal to the degree of blockage applied within said mesh points 609, 504 compressing the encompassed transmission fluid within said mesh points 609, 504 and the said locking action would also be further controlled by the amount of transmission fluid 800 continuously available to replenish said mesh points 609, 504 as the sun gear and planetary gears 500, 600 rotate against each other as the input torque speed ITS of the sun gear 500 relative to the housing 200 output torque speed OTS varies; any degree of mesh point 609, 504 blockage results in the sun gear's 500 gear teeth 501 locking onto the connected planetary gear's 600 gears teeth 601 to the equivalent to that of any blockage at any point within the planetary gear train 615; a minor blockage within the mesh points 609, 504 resulting in more “slip” between the sun gear 500 and housing 200 input and output drives DI, DO; a major blockage resulting in far less “slip” between the sun gear 500 and housing 200 input and output drives DI, DO; any and all blockages within said mesh points 609, 504 being cumulative resulting in a smooth drive sequence;
therefore any and all mesh point 609, 504 blockages or part blockages inhibiting rotation of the planetary gear train 615 teeth 601 relative to the sun gear's 500 teeth 501, said planetary gear train 615 planetary gear axles 605 then always trying to turn at the same speed as the corresponding sun gear 500 input torque speed ITS when there is insufficient load to reduce the output torque speed OTS;
as the housing 200 is mechanically connected to the planetary gears 600 by the planetary gear axles 605 the housing 200 is normally driven in the same forward or reverse drive direction D, R as the driven sun gear 500;
conversely the housing 200, if driven by the power unit 900 would drive the sun gear 500 according to any blockages within said mesh points 609, 504.

2. A progressive limited slip differential 1 as claimed in claim 1, further characterised in that the rotational deviation of the housing 200 to that of the sun gear 500 is by the mechanical connection of the planetary gear axles 605 rotationally held within their planetary gear axle bores 604 within the planetary gear bearings 611 within the housing 200 inner end plates 303.

3. A progressive limited slip differential 1 as claimed in claim 2, is further characterised by its use of shaped internal spacers 400 which, in conjunction with the robustly attached generally planar first and second end plate sets 301, 302, form inward and outward fluid feed passageways 402, 403 adjacent to the planetary gears 600 within the housing 200.

4. A progressive limited slip differential 1 as claimed in claim 3, further characterised wherein any near locking action caused by the encapsulation or semi encapsulation of said transmission fluid 800 within said planetary and sun gear teeth mesh points 609, 504, providing a progressive locking action between the central, sun gear 500 and the housing 200 assembly, the output torque speed OTS is always trying to adjust to the input torque speed ITS, when the sun gear 500 relative to the housing 200 turning speed varies; the rotational deviation; the planetary gear or gears 600 will therefore turn within said housing 200, feeding transmission fluid 800 inwards to more central mesh points 609, for example the first being the outer planetary gear 608 mesh points 609 then next into the intermediate planetary gear 607 mesh points 609; wherein as each additional mesh point 609, 504, as it is filled with said transmission fluid, creating an additional impedance or blockage and therefore reducing any rotational deviation between said housing 200 and sun gear 500 input torque speed ITS and output torque speed OTS; if there is little or no rotational deviation, there is less or no feeding of transmission fluid 800 to further mesh points 609, 504 as there is less or no requirement for it; the progressive limited slip differential 1 can be configured by its chosen value transmission fluid 800 viscosity and its planetary gear mesh points 609, 504 tolerances to have almost limitless pre-ordained settings and therefore almost limitless pre-ordained levels of rotational deviation, or lack of it, between said housing 200 and sun gear 500 input torque speed ITS and output torque speed OTS.

5. A progressive limited slip differential 1 as claimed in previous claims, is further characterised wherein, as the progressive limited slip differential 1 is subjected to considerable rotational velocity, the transmission fluid 800 contained within the sealed housing 200 is subject to substantial corresponding centrifugal forces urging the said transmission fluid 800 outwards into said void or transmission fluid centrifugal reservoir 801 created; when the housing 200 is rotating, the contained transmission fluid 800 is spun by the considerable applied centrifugal force to the degree corresponding to the rotating housing 200 velocity; the transmission fluid 800 being spun towards the transmission fluid centrifugal reservoir 801, creating an outer transmission fluid reservoir during rotation 803, adjacent the outer casing inner wall 206; said centrifugal force compressing said transmission fluid 800 therein, squeezing out entrained bubbles from said transmission fluid 800, therefore reducing the potential problematic compressibility of a transmission fluid 800/air mix within the mesh points 609, 504, resulting in less or no aerated compression of the transmission fluid 800 utilised within the mesh points 504, 609, as hydraulic transmission fluid 800 is generally non compressible it does not heat up when continually compressed or released; however said transmission fluid 800 is in contact with a proportionally large housing 200 surface area which, when the correct materials are used ensures good heat dissipation and ambient heat transfer helping to provide a stable transmission fluid 800 temperature.

6. A progressive limited slip differential 1 as claimed in any one of the preceding claims, wherein the planetary gears 600 can be utilised singly or in multiple gears 600 within a set 616.

7. A progressive limited slip differential 1 as claimed in any one of the preceding claims, wherein said housing 200, with its internal, central sun gear 500 and corresponding planetary gear or gears 600, takes the form of a deliberately part filled, sealed container for the retained transmission fluid 800 required within said housing 200; said transmission fluid 800 furthermore in use lubricating said sun and planetary gear teeth 501, 601 and planetary gear axles 605.

8. A progressive limited slip differential 1 as claimed in any one of the preceding claims, further characterised by the use of differing set tolerances between the various sets of meshing sun and planetary gear teeth 501, 601 employed; the tolerances being progressively finer and therefore the pumping resistance or near locking action being greater the nearer to the central sun gear 500, resulting in a progressive resistive or near locking action between the sun gear 500 and housing 200 within the progressive limited slip differential 1.

9. A progressive limited slip differential 1 as claimed in any one of the preceding claims, further characterised by the capability of its use with differing transmission fluid 800 viscosities according to the application requirement; for greater pumping resistance or near locking action, a transmission fluid 800 of greater viscosity requires to be used, resulting in an equivalent earlier progressive resistive or near locking action between the sun gear 500 and housing 200 within the progressive limited slip differential 1.

10. A progressive limited slip differential 1 as claimed in any one of the preceding claims, further characterised in that the maximum coupling speed between the input torque speed ITS and the output torque speed OTS can be preset to suit the required purpose.

11. A progressive limited slip differential 1 as claimed in any one of the preceding claims, further characterised by the fact that the progressive limited slip differential 1 can be subjected to substantial rotational velocity in normal use, yet the sun gear 500 “slip” relative to the planetary gear train 615 is separately governed by the input torque speed ITS compared to the output torque speed OTS; the planetary gear train 615 seldom turns at any great speed around the sun gear 500 before the saturated mesh points 504, 609 increase the output torque speed OTS towards the input torque speed ITS.

12. A progressive limited slip differential 1 as claimed in any one of the preceding claims, wherein the spacer fluid passageway walls 401 are a close fit to the adjacent planetary gear teeth 601 peripheries in order to form a method of transmitting the transmission fluid 800 when said planetary gears 600 rotate according to any variation in input torque speed ITS to the corresponding output torque speed OTS, the planetary gears 600 acting like paddle wheels, transmitting any entrapped transmission fluid 800 within the gear teeth roots 603 as they rotate; delivering said transmission fluid from the transmission fluid centrifugal reservoir 801 towards the various planetary and sun gear mesh points 609, 504.

13. A progressive limited slip differential 1 as claimed in any one of the preceding claims, further characterised in that, when or if the power unit 900 energy is withdrawn or input torque speed ITS is reduced, the progressive limited slip differential 1 can quickly and smoothly work in the opposite drive direction D, R using the power unit 900 or power source as an additional vehicle braking means.

14. A progressive limited slip differential 1 as claimed in any one of the preceding claims, further characterised by the layout of the spacer inward and outward fluid passageways 402, 403, resulting in different amounts of transmission fluid 800 being fed to the mesh points 504, 609 of the opposing planetary and sun gears 600, 500; in best practice, when the progressive limited slip differential 1 is driven in the reverse direction R, the spacer outward fluid flow passageways 403 used to drain the mesh points 504, 609 in said reverse direction R, are wider than that of the inward fluid flow passageways 402 used to feed the mesh points 504, 609 in the normal forward direction D, resulting in the planetary gears 600 having to rotate faster to feed the same amount of transmission fluid 800 to the mesh points 504, 609 in the reverse direction R, giving dissimilar resistive or locking characteristics in forward and reverse directions D, R.

15. A progressive limited slip differential 1 as claimed in any one of the preceding claims, wherein the housing 200 is only part filled with transmission fluid 800 to a set level whereby even the transmission fluid level at rest 802 saturates at least one planetary gear mesh point 609 or further planetary gear mesh points 609; thereby giving instant drive between the central sun gear 500 and the housing 200, even after long periods of inactivity; this would constitute an initial blockage or locking action to a degree determined by the tolerances and profiles 602, 502 of the engaged planetary 600 or sun 500 gear teeth mesh points 609, 504 and viscosity of the particular transmission fluid 800 employed.

16. A progressive limited slip differential 1 as claimed in any one of the preceding claims, further characterised wherein the housing 200 is only part filled with transmission fluid 800 to a pre-ordained level when the transmission fluid level at rest 802 via an opening and sealed with a plug (not shown) in order to help define a fluid tight sealing configuration.

17. A progressive limited slip differential 1 as claimed in any one of the preceding claims, further characterised wherein the outer casing compressible seal 204 utilised between the outer casing compressible seal groove 203 and the inner end plate 303 of the corresponding first and second end plate sets 301, 302, enables serviceable adjustment of the tolerances between the planetary gear lateral planar surfaces 610 and the planetary gear bearing thrust surfaces 612, ensuring the minimum lateral leakage from their mesh points 504, 609.

18. A progressive limited slip differential 1 as claimed in any one of the preceding claims, further characterised wherein the lengths of the planetary and sun gears 600, 500 are standardised, normally by final grinding, and that they and the assembly bolts 700 and fasteners 701 within the outer casing assembly holes 202 and location pins 702 within their corresponding endplate location pin holes 309 are made from material with the same co-efficient of expansion, in order, that as much as possible, the mesh point 504, 609 tolerances do not unduly vary under thermal stresses.

19. A progressive limited slip differential 1 as claimed in any one of the preceding claims, further characterised by the use of straight cut planetary and sun gears 600, 500, which are not only the lowest cost to produce but usually require no expensive thrust bearings.

20. A progressive limited slip differential 1 as claimed in any one of the preceding claims, further characterised where in best practice for balancing and construction strength purposes, a minimum of three generally equidistantly spaced planetary gears or gear train sets 600, 616 are utilised, comprising in one example of inner, intermediate and outer planetary gears 606, 607 and 608; said gears 606, 607 and 608 having their central gear axles 605 rotatably located within the top hat shaped, plain, planetary gear bearings 611, which are in turn located within the inner end plate bearing lip recesses 304; said plain planetary gear bearings 611 are further prevented from rotating by the planetary gear bearings anti-rotational profiles 614;

21. A progressive limited slip differential 1 as claimed in any one of the preceding claims, wherein the tolerances between the opposing planetary gear teeth 601 or between the sun gear teeth 501 and planetary gear teeth 601, have progressively tighter tolerances within the planetary gear mesh points 609 the nearer they are to the sun gear mesh points 504, the tighter the meshing tolerances between said planetary and or sun gear teeth 601, 501 creating a progressively enhanced degree of blockage or impedance to any rotation of said planetary gears 600 when said planetary gear mesh point or points 609 are part filled or filled with transmission fluid 800; the outer planetary gear 608 mesh points being the first to be filled with transmission fluid 800 creating the least degree of blockage or impedance, the intermediate planetary gear 607, mesh points 609 being the next to be filled with transmission fluid 800, creating a greater degree of blockage or impedance; the inner planetary gears 606 to sun gears 500 mesh points 504 when filled with transmission fluid creating a far greater degree of blockage or impedance; the degree of planetary gear or sun gear mesh points 609, 504 blockage or impedance being cumulative, effectively spreading the impeding or near locking function over the entire planetary gear train sets 616 and thereby all the planetary gear axles 605.

22. A progressive limited slip differential 1 as claimed in any one of the preceding claims wherein the normal return outward fluid flow passageways 403 are increased in size to allow extra leakage from the mesh points 504, 609 back towards the transmission fluid centrifugal reservoir 801, resulting in the planetary gears 600 having to spin slightly faster against any outward centrifugal force applied to the transmission fluid 800 to enable said transmission fluid 800 to be capable of instantly reducing any mesh point 504, 609 transmission fluid 800 quantity, resulting in greater slip;
at the point of which the vehicle outer road wheels 902 start to rotate more easily and faster than the inner road wheels 902, the outer progressive limited slip differential's 1 planetary gears 600 tend to reverse their normal drive direction D, aiding this action and reversing any transmission fluid 800 flow from any filled mesh points 504, 609, substantially reducing the degree of locking action available and allowing greater “slip” between the outer road wheels 902 and the inner road wheel 902 as required.

23. A progressive limited slip differential 1 as claimed in any one of the preceding claims wherein the sealed housing 200 cavity during manufacture or servicing prior to use, is subjected to a high level of vacuum wherein the transmission fluid 800 contained within said housing 200 centrifugal reservoir 801 remains under vacuum and relatively air bubble free at all times as there is virtually no air present within said housing 200.

24. A progressive limited slip differential 1 as claimed in any one of the preceding claims wherein when utilised as a method of preventing unwanted mechanical damage when the likes of a driven marine propeller (not shown) is suddenly prevented from turning, chosen mesh points 504, 609, incorporate known preset pressure relief valves (not shown), in order to prevent any transmission fluid 800 within said tolerance mesh points 504, 609 causing a near or absolute blockage.

25. A progressive limited slip differential 1 as claimed in any one of the preceding claims wherein the power unit 900 comprises of a dual drive electric motor 904 with its central rotor shaft 905 protruding outwith either end of its known casing; said dual drive electric motor's 904 rotor shaft 905 incorporating rotor dual drives 906, one on each extremity of said rotor shaft 905, a progressive limited slip differential 1 being connected to each of the rotor dual drives 906; said progressive limited slip differentials 1 being further connected via output drive shafts 903 to the road wheels 902; known constant velocity joints (not shown) may also be employed, whilst the use of an expensive known differential (not shown) is unnecessary, thus the drive of an electrically driven vehicle in slippery or off road conditions can be vastly improved at a nominal cost.

26. A dual drive electric motor 904 as claimed in claim 31 wherein the power unit 900 comprises of a electric motor 904 specifically designed for motor vehicle drives; whereas its central rotor shaft 905 protrudes outwith either end of the known stator housing 907; said dual drive electric motor's 904 rotor shaft 905 incorporating rotor dual drives 906, one on each extremity of said rotor shaft 905.

27. A progressive limited slip differential 1 as claimed in any one of the preceding claims, wherein in order to further ensure adequate transmission fluid 800 is transmitted to the progressively inward mesh points 609, 504 as required, various end plate port holes 311 and first and second fluid channels 312, 313 are incorporated within either or both the housing first and second end plate sets 301, 302, said end plate sets 301, 302 having the end plate port holes 311 and end plate first and second fluid channels 312, 313 connecting points just before the mesh points 609, 504 inward transmission fluid 800 flow mesh points 609, 504.

28. A limited slip drive comprising:
a housing assembly,
a sun gear disposed in said housing assembly and comprising a plurality of sun gear teeth;
a plurality of planetary gears engaging said sun gear in said housing and each comprising planetary gear teeth that mesh with said sun gear teeth to define respective meshing positions;
a reservoir for a non-compressible transmission fluid defined in said chamber;
a first drive connector connected to said sun gear;
a second drive connector connected to the housing assembly; and
respective passages defined by said housing assembly between said reservoir and a centrally disposed passage in which said sun gear is disposed,
wherein said passages are configured to provide a clearance around said planetary gears and sun gear meshing positions that restricts flow of said transmission fluid when due to a rotational speed differential between said housing assembly and said sun gear said planetary gears pump said transmission fluid from said reservoir along the respective said passages so as to provide a hydraulic locking action at said meshing positions that restricts relative rotation of said sun gear and planetary gears to provide slip limitation between said sun gear and housing assembly.

29. A limited slip drive as claimed in claim 28, comprising three said planetary gears disposed about said sun gear at equi-spaced angular intervals.

30. A limited slip drive as claimed in claim 28 or 29, wherein each said planetary gear is a part of a respective gear train disposed in said passage and each gear train comprises at least one further planetary gear, the planetary gears and further planetary gears of each said gear train being disposed in series such that said gear trains extend at least substantially radially with respect to said sun gear.

31. A limited slip drive as claimed in claim 30, wherein the further planetary gears of said gear trains mesh with an adjacent planetary gear of adjacent planetary gears of the gear train at respective meshing positions and the respective passages are configured to provide a progressively increased clearance around meshing positions along said passages so as to provide increased flow restriction along said passages so that said slip limitation progressively increases as, in use, said planetary gears pump said transmission fluid along said passages.

32. A limited slip drive as claimed in any one of claims 28 to 31, wherein said housing assembly defines a reservoir for said non-compressible fluid that is disposed radially outwardly of said planetary gears and extends circumferentially about said housing assembly.

33. A limited slip drive as claimed in any one of claims 28 to 32, wherein said housing assembly is provided with a valve configured to allow evacuation of said housing assembly by a vacuum source.

34. A limited slip drive as claimed in any one of claims 28 to 33, wherein said housing assembly comprises:
a peripherally circumferentially extending outer wall, a first end wall closing an opening defined at a first end of said outer wall and a second end wall closing an opening defined at a second end of said outer wall to form an enclosure; and
inner walls extending between said first and second end walls to define said passages.

35. A limited slip drive as claimed in claim 34, wherein said inner walls are defined by a plurality of spacer members disposed between said first and second end walls.

36. A limited slip drive as claimed in claim 35, wherein each planetary gear has a first end and a second end and each planetary gear has a first planetary gear bearing supporting said first end and a second planetary gear bearing supporting said second end, said first planetary gear bearings being supported by said first end walls and said second planetary gear bearing being supported by said second end walls.

37. A limited slip drive as claimed in claim 34, 35 or 36, wherein each said end wall comprises a set of end plates disposed one upon another to form an end plate set.

38. A limited slip drive as claimed in any one of claims 28 to 36, further comprising a said transmission fluid, said transmission fluid only partially filling said reservoir and passageways.
